(19) United States
(12) Patent Application Publication
(10) Pub. No.: US 2025/0332973 A1
(43) Pub. Date: Oct. 30, 2025

(54) DEVICE FOR ATTACHING A HEADREST TO A VEHICLE SEAT AND ASSOCIATED VEHICLE SEAT

(71) Applicant: Faurecia Sièges d'Automobile, Nanterre (FR)

(72) Inventors: Philippe CHARLES, LUXEUIL LES BAINS (FR); Thomas DANNER, Walbrzych (PL)

(21) Appl. No.: 19/189,184

(22) Filed: Apr. 24, 2025

(30) Foreign Application Priority Data
Apr. 29, 2024 (FR) FR 24 04445

(51) Int. Cl. B60N 2/818; B60N 2/815

(52) U.S. Cl. CPC B60N 2/818; B60N 2/815

(57) ABSTRACT

A device for attaching a headrest to a vehicle seat with the possibility of adjusting the headrest relative to the vehicle seat according to an adjustment axis. The device for attaching includes a receiving space for receiving a support element of the headrest, a locking element movable between a locking position and an unlocking position, a control member, and a transmission mechanism having at least one rotatable transmission element movable in rotation around a rotation axis parallel to the adjustment axis. Rotation of each transmission element causes the displacement of the locking element from the locking position to the unlocking position.

### TECHNICAL FIELD

The present invention relates to a device for attaching a headrest to a vehicle seat and an associated vehicle seat.

### BACKGROUND

A vehicle seat headrest generally comprises a support element, in particular, intended to support the head of a passenger, and at least one support element, for example, a fixing rod, attached to the seat by an attachment device.

In order to allow, in particular, height adjustment of the support element relative to the back of the seat, the support element, for example, a fixing rod, is attached in a manner moveable in translation, substantially vertical, on the backrest of the seat.

Generally, the device for attaching also comprises a locking device allowing the movement in translation of the fixing rod to be blocked and thus immobilize the support element in a predefined position.

In a known manner, this locking device is, for example, a locking button, particularly located at the top of the fixing rod. Alternatively, it is also known to arrange the locking device at the bottom of the fixing rod. However, such locking devices are usually formed by a complex mechanism.

Furthermore, such locking devices may rely on a vertical transmission of a control movement between a control member and a locking element, which leads to a risk of friction and thus reduces the robustness of these.

Alternatively, such locking devices may, for example, be formed by a lever arm movable around a pivot in rotation, which allows the lock to leave the movement of the headrest in translation free.

### SUMMARY

One of the aims of the invention is to propose a robust and easy-to-assemble device for attaching a headrest to a vehicle seat.

To this end, the invention has as one object a device for attaching a headrest to a vehicle seat with the possibility of adjusting the headrest relative to the vehicle seat according to an adjustment axis, the device for attaching comprises a receiving space for receiving a support element of the headrest, a locking element, movable between a locking position in which the locking element blocks the support element in translation according to the adjustment axis and an unlocking position in which the locking element frees the support element in translation according to the adjustment axis, a control member, and a transmission mechanism comprising at least one rotatable transmission element movable in rotation around a rotation axis parallel to the adjustment axis, a rotation of each transmission element causing the locking element to displace from the locking position to the unlocking position.

According to particular embodiments, the device for attaching comprises one or more of the following features, taken alone or according to any technically possible combination:
The control member is movable in translation according to a direction in translation perpendicular to the adjustment axis.
The rotation axis of each transmission element is distinct from the adjustment axis.
The rotation axis of each transmission element coincides with the adjustment axis.
The device for attaching comprises a tubular sleeve delimiting the receiving space, each transmission element being rotatably mounted on the tubular sleeve, preferably on the outside of the tubular sleeve.
The locking element is movable in translation between the locking position and the unlocking position.
The locking element is movable in translation along a translation axis perpendicular to the adjustment axis, preferably radial relative to the adjustment axis.
The locking element extends into the receiving space in the locking position and is clear of the receiving space or extends less into the receiving space in the unlocking position.
Each transmission element comprises a first cooperation element by means of which it engages with the control member and a second cooperation element by means of which it engages with the locking element.
The first cooperation element and the second cooperation element are distant from each other, according to the rotation axis of the transmission element.
The transmission mechanism comprises two transmission elements.
The two transmission elements pivot in opposite rotation directions to displace the locking element from the locking position to the unlocking position.
The device for attaching comprises a return device comprising at least one elastic return member arranged to return the locking element from the unlocking position to the locking position.

The invention also relates to an automotive vehicle seat comprising a backrest equipped with a device for attaching, such as described above, for attaching a headrest to the backrest of the seat, the receiving space being preferably arranged in the backrest of the seat.

### BRIEF DESCRIPTION OF THE DRAWINGS

The invention and its advantages will be better understood by reading the following description, given solely by way of a non-limiting example, and made with reference to the appended drawings, in which:

FIG. 1 is a schematic view of elements of a vehicle seat comprising a device for attaching according to an embodiment of the invention;

FIG. 2 is a schematic side view of a device for attaching according to a first embodiment of the invention;

FIG. 3 is a sectional view according to the axis III-III of the device for attaching of FIG. 2 with the locking element in the locking position;

FIG. 4 is a sectional view according to the axis III-III of the device for attaching of FIG. 2 with the locking element in the unlocking position; and

FIGS. 5 and 6 are sectional views of a device for attaching according to a second embodiment of the invention in the locking position (FIG. 5) and in the unlocking position (FIG. 6).

FIGS. 7 and 8 are sectional views of a device for attaching according to a third embodiment of the invention in the locking position (FIG. 7) and in the unlocking position (FIG. 8).

### DETAILED DESCRIPTION

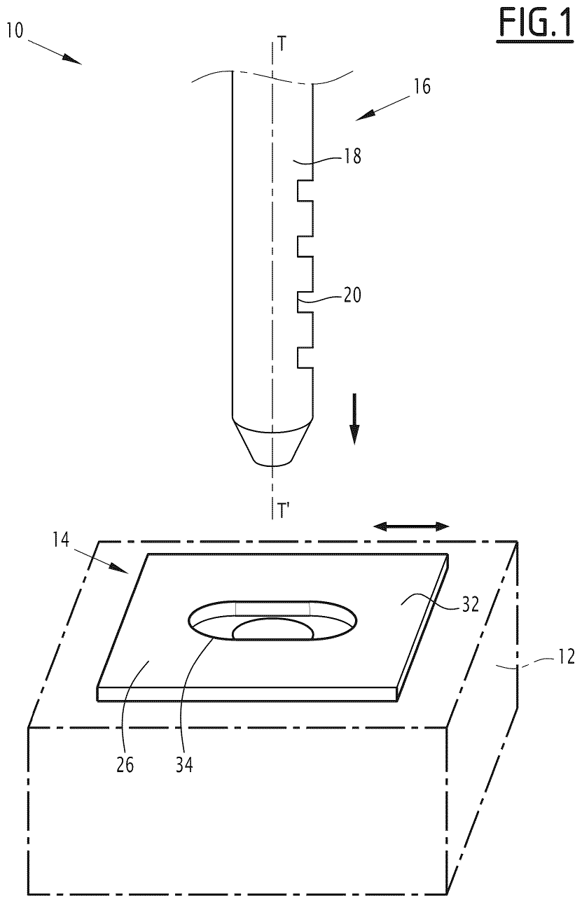

FIG. 1 illustrates elements of a vehicle seat 10, particularly an automotive vehicle.

The seat 10 comprises a seat backrest 12 configured to define a known support surface for a passenger seated on the seat 10.

The seat 10 is equipped with a device for attaching 14 a headrest 16 to the backrest 12 of the seat.

A headrest 16 comprises more specifically a support element (not illustrated), intended to support the head of a passenger, and at least one support element 18.

As illustrated in FIG. 1, the support element 18 of the headrest 16 is, for example, a rod extending according to a rod axis T-T′.

The support element 18 comprises, for example, at least one notch 20, and preferably a plurality of notches 20 spaced apart according to the rod axis T-T′.

The device for attaching 14 is configured to attach the headrest 16 to the backrest 12 with the possibility of adjusting the headrest 16 relative to the vehicle seat 10 according to an adjustment axis R-R′.

When the headrest 16 is attached to the backrest 12, the adjustment axis R-R′ is preferably substantially parallel to the rod axis T-T′ of the support element 18.

In particular, the adjustment axis R-R′ is substantially vertical when the seat 10 is mounted in the automotive vehicle in a normal use configuration.

In other words, the device for attaching 14 allows height adjustment of the headrest 16, and in particular of the position of its support element (not illustrated).

The device for attaching 14 comprises a receiving space 22, a locking element 24, a control member 26, and a transmission mechanism 28.

The receiving space 22 is able to receive the support element 18 of the headrest 16.

More particularly, the receiving space 22 is configured so as to allow the movement in translation of the support element 18 according to the adjustment axis R-R′, so as to adjust the headrest 16 relative to the seat 10. The support element 18 is received in the receiving space 22, by being slidable according to the adjustment axis R-R′.

The receiving space 22 is preferably provided in the backrest 12.

According to a particular embodiment, the device for attaching 14 comprises a tubular sleeve 30 delimiting the receiving space 22.

In particular, the tubular sleeve 30 extends according to the adjustment axis R-R′ and is provided in the backrest 12.

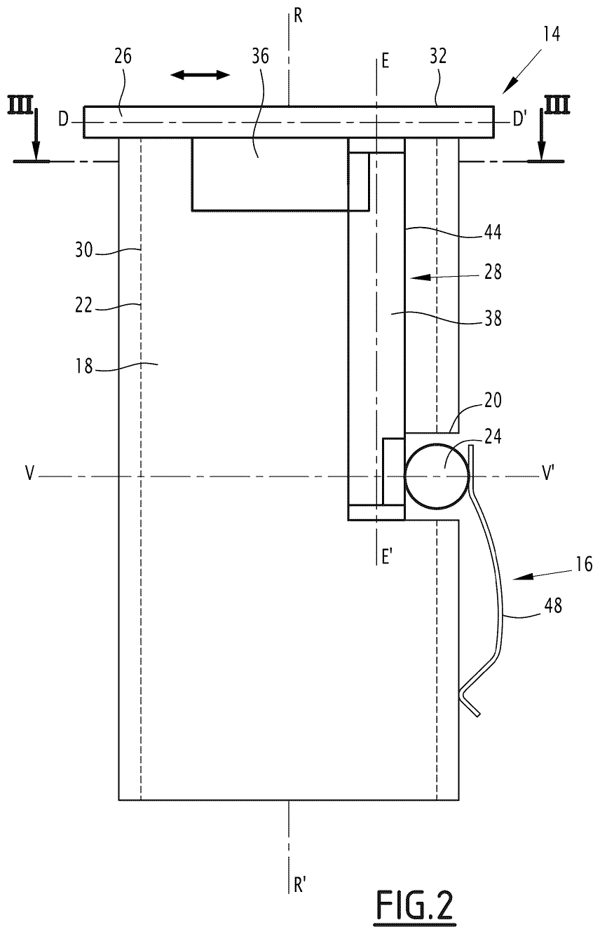

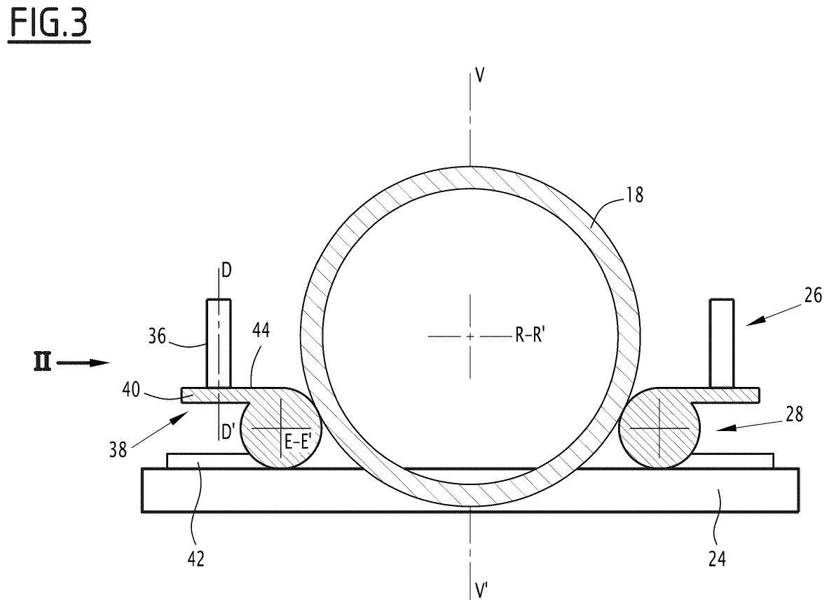

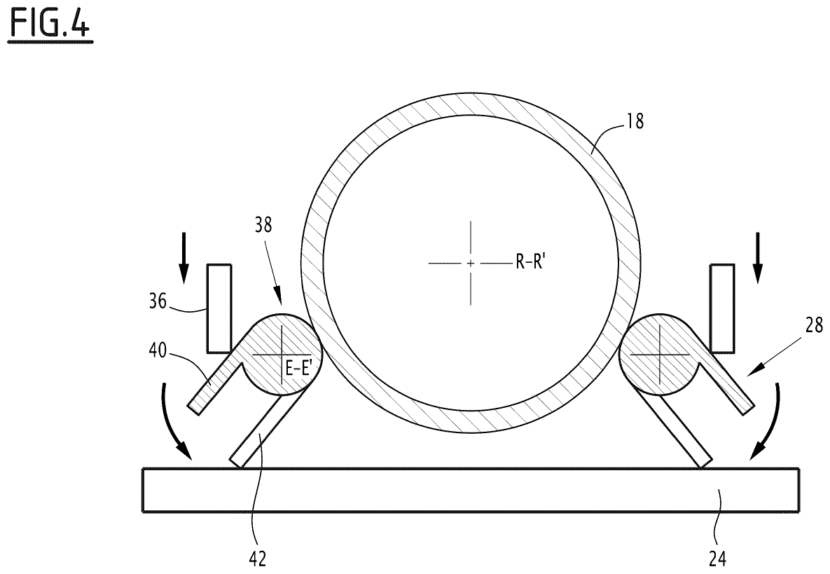

The locking element 24 is movable between a locking position illustrated in FIGS. 2 and 3 and an unlocking position illustrated in FIG. 4.

Preferably, the locking element 24 is movable in translation according to a translation axis V-V′ between the locking position and the unlocking position.

Advantageously, the translation axis V-V′ is perpendicular to the adjustment axis R-R′, preferably radial relative to the adjustment axis R-R′.

In the locking position, the locking element 24 blocks the support element 18 in translation according to the adjustment axis R-R′.

In particular, in the locking position, the support element 18 is not movable in translation according to the adjustment axis R-R′ in the receiving space 22.

More precisely, the locking element 24 extends into the receiving space 22 in the locking position, so as to prevent the movement in translation of the support element 18 in the receiving space 22.

In one particular embodiment of the invention illustrated in FIG. 2, in the locking position, the locking element 24 is, for example, housed in one of the notches 20 provided in the support element 18.

In the unlocking position, the locking element 24 frees the support element 18 in translation according to the adjustment axis R-R′.

In particular, in the locking position, the support element 18 is movable in translation according to the adjustment axis R-R′ in the receiving space 22.

More precisely, the locking element 24 is clear of the receiving space 22 or extends less into the receiving space 22 in the unlocking position, so as to allow the translation of the support element 18 in the receiving space 22.

The locking element 24 is, for example, formed by a cylinder extending according to a cylinder axis, particularly perpendicular to the adjustment axis R-R′ and the translation axis V-V′.

The locking element 24 presents, for example, a round, square, rectangular, or oblong section.

Advantageously, the control member 26 is movable in translation according to a direction of translation D-D′ perpendicular to the adjustment axis R-R′.

Preferably, the direction of translation D-D′ is substantially parallel to the translation axis V-V′ of the locking element 24.

For example, the control member 26 is manually operable by a passenger to unlock/lock the support element 18.

More particularly, as will be explained in more detail below, the translation of the control member 26 from a first position (FIG. 3) to a second position (FIG. 4) drives the translation of the locking element 24 from the locking position to the unlocking position.

The control member 26 comprises, for example, an upper plate 32 defining an opening 34, which preferably defines the insertion opening of the receiving space 22, and in particular, of the tubular sleeve 30.

Advantageously, the upper plate 32 extends in a plane perpendicular to the receiving space 22.

Preferably, the control member 26 comprises at least one tab 36, and preferably two tabs 36, each extending in projection from the upper plate 32 toward the receiving space 22.

The transmission mechanism 28 comprises at least one transmission element 38.

As illustrated in FIGS. 3 and 4, the transmission mechanism 28 preferably comprises two transmission elements 38.

Each transmission element 38 is rotatable, and in particular movable in rotation around a rotation axis E-E′ parallel to the adjustment axis R-R′.

For example, in the embodiment illustrated in FIGS. 3 and 4, each transmission element 38 is rotatably mounted on the tubular sleeve 30, preferably inside the tubular sleeve 30.

In the particular embodiment of the invention illustrated in FIGS. 3 and 4, the rotation axis E-E′ of each transmission element 38 is distinct from the adjustment axis R-R′.

Preferably, each transmission element 38 is rotatably mounted by means of the pivot elements.

More specifically, in this particular embodiment, the rotation axes E-E′ of the two transmission elements 38 are equidistant from the adjustment axis R-R′, and, in particular, extend on either side of the support element 18. Preferably, each transmission element 38 comprises a first cooperation element 40 by means of which it engages with the control member 26 and a second cooperation element 42 by means of which it engages with the locking element 24.

For example, in the particular embodiment illustrated in FIGS. 3 and 4, each transmission element 38 comprises a rod 44 extending according to the rotation axis E-E′ and two tabs projecting from the rod 44, each respectively defining the first cooperation element 40 and the second cooperation element 42.

In this embodiment, the rod 44 of each transmission element 38 is, for example, in contact with the support element 18.

Advantageously, the first cooperation element 40 and the second cooperation element 42 are at a distance from each other according to the rotation axis E-E′ of the transmission element 38.

For example, in the particular embodiment illustrated in FIGS. 3 and 4, the first cooperation element 40 and the second cooperation element 42 are at different heights along the rod 44.

More particularly, the first cooperation element 40 is, for example, arranged at the upper end of the rod 44, and the second cooperation element 42 is, for example, arranged at the lower end of the rod 44. The upper end of the rod 44 is close to the control member 26. The lower end of the rod 44 is away from the control member 26.

Preferably, the translation of the control member 26 is configured to drive the rotation of each transmission element 38.

For example, during the movement in translation of the control member 26 from its first position illustrated in FIG. 3 to its second position illustrated in FIG. 4, the control member 26, in particular each of its tabs 36, is configured to come into contact with each transmission element 38 and, in particular, to push the first cooperation element 40, so as to drive the rotation of each transmission element 38 around its rotation axis E-E′.

Each transmission element 38 is further configured so that its rotation causes the displacement of the locking element 24 from the locking position to the unlocking position.

In the embodiment illustrated in FIGS. 3 and 4, in which the transmission mechanism 28 comprises two transmission elements 38, the two transmission elements 38 pivot in opposite rotation directions to displace the locking element 24 from the locking position to the unlocking position.

For example, as illustrated in FIG. 4, each transmission element 38 is configured so that its rotation drives a rotation of the second cooperation element 42, which pushes the locking element 24, thus driving its translation from the locking position to the unlocking position.

In other words, the transmission mechanism 28 is configured so as to transform the movement in translation of the control member 26 from the first position to the second position into a movement in translation of the locking element 24 from the locking position to the unlocking position.

Each transmission element 38 of the transmission mechanism 28 is, for example, made of plastic.

Advantageously, the device for attaching 14 further comprises a return device 46 comprising at least one elastic return member 48 arranged to return the locking element 24 from the unlocking position to the locking position.

In particular, when the control member 26 is moved from the second position to the first position, the elastic return member 48 drives the translation of the locking element 24 from the unlocking position (FIG. 4) to the locking position (FIG. 3), particularly so as to lock the support element 18 in the desired position.

As illustrated in FIG. 2, the elastic return member 48 is, for example, a leaf spring linked to the locking element 24 and in contact with the support element 18.

Attaching the headrest 16 to the backrest 12 of the seat and adjusting the headrest 16 relative to the vehicle seat 10 by the device for attaching 14 as described above will now be described.

As illustrated in FIG. 1, the support element 18 of the headrest 16 is inserted into the receiving space 22, and in particular, into the tubular sleeve 30 according to the adjustment axis R-R′.

Following this insertion, the locking element 24 is in the locking position. In particular, the locking element 24 is housed in the receiving space 22, and, for example, in one of the notches 20 provided in the support element 18.

The control member 26 is in its first position, as illustrated in FIG. 3.

The headrest 16 is thus attached to the backrest 12 at a first height relative to the vehicle seat 10.

For an adjustment of the headrest 16 relative to the vehicle seat 10, the control member 26 is displaced from its first position to its second position according to the direction of translation D-D′ perpendicular to the adjustment axis R-R′, for example, under the action of a user pressing a push button linked to the control member 26.

Said movement in translation of the control member 26 from the first position to the second position is transmitted by the transmission mechanism 28 into a movement in translation of the locking element 24 from the locking position to the unlocking position.

In particular, during the translation of the control member 26 from its first position illustrated in FIG. 3 to its second position illustrated in FIG. 4, the control member 26, in particular each of its tabs 36, comes into contact with each transmission element 38 and, in particular, pushes each first cooperation element 40, thus driving the rotation of each transmission element 38.

The rotation of each transmission element 38 drives a rotation of the second cooperation element 42, which pushes the locking element 24, thus driving its translation from the locking position to the unlocking position as illustrated in FIG. 4.

The support element 18 of the headrest 16 can then be displaced in translation according to the adjustment axis R-R′ to the desired position.

Preferably, thanks to the elastic return member 48, the locking element 24 then automatically returns to the locking position, so as to block the headrest 16 in the new position.

Such a device for attaching 14 allows adjustable attachment of a headrest 16 to a seat 10.

In particular, relative to the known state of the art, the device for attaching 14 allows locking and unlocking without using a complex mechanism, thanks in particular to the transmission mechanism 28 comprising transmission elements 38 that are easy to assemble.

Furthermore, such a device for attaching 14 is robust, particularly due to a reduction in the risk of friction, particularly thanks to the spacing between the first cooperation element 40 and the second cooperation element 42 of each transmission element 38.

The invention is not limited to the previously described embodiments and alternatives.

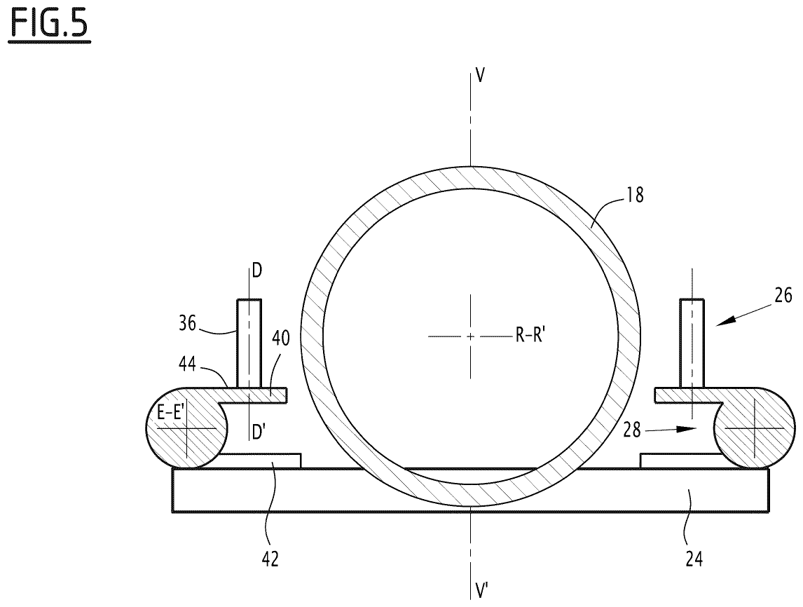

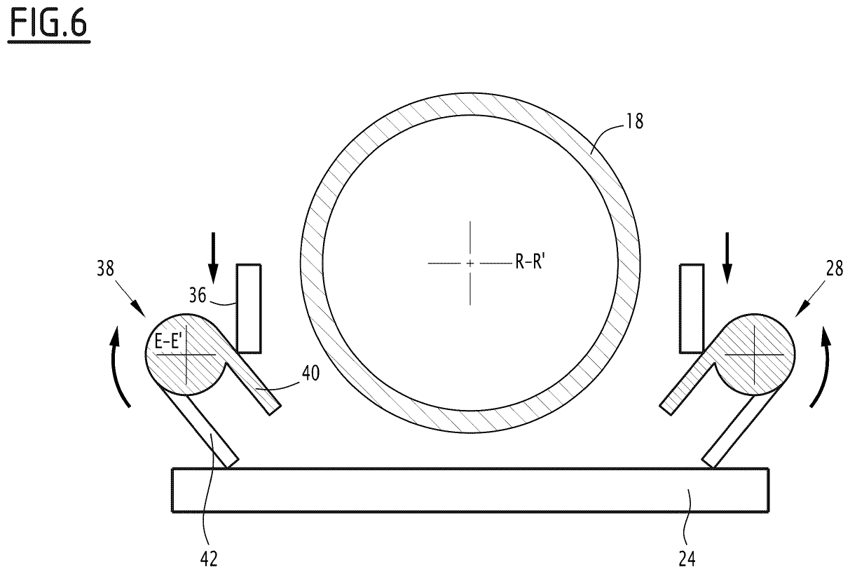

In particular, a device for attaching 14 according to a second embodiment of the invention illustrated in FIGS. 5 and 6 is described below.

The second embodiment differs from the first embodiment only in the position of the transmission element(s) 38.

In particular, in this specific second embodiment, the rotation axis E-E′ of each transmission element 38 is located outside the tubular sleeve 30.

More particularly, as visible in FIGS. 5 and 6, the rods 44 of each transmission element 38 are not in contact with the support element 18.

This second embodiment presents the advantage of presenting a smaller footprint than the first embodiment.

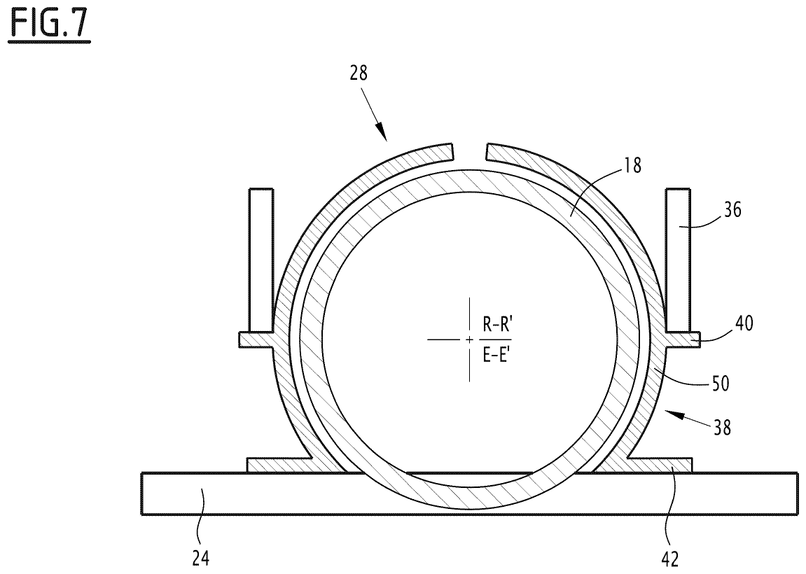

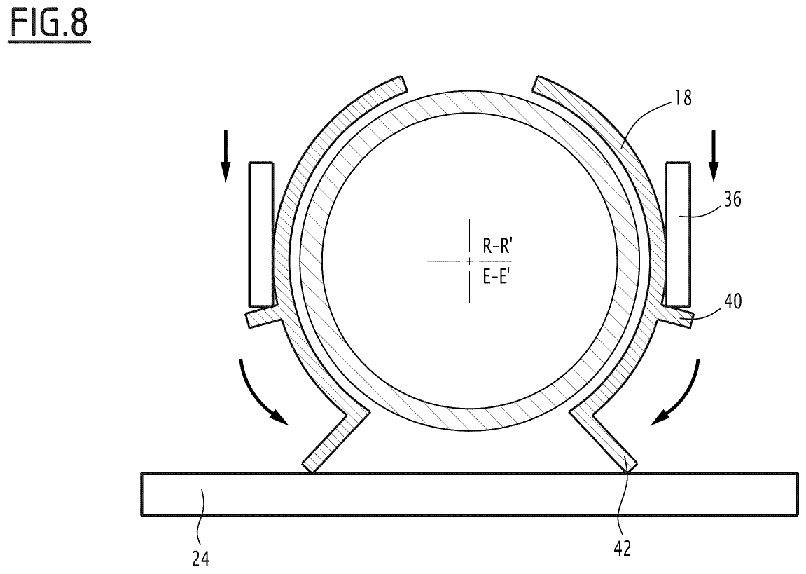

Furthermore, a device for attaching 14 according to a third embodiment of the invention illustrated in FIGS. 7 and 8 is described below.

The third embodiment differs from the first embodiment only in the transmission element(s) 38.

In particular, in this specific third embodiment, the rotation axis E-E′ of each transmission element 38 coincides with the adjustment axis R-R′.

For example, as illustrated in FIGS. 7 and 8, in this embodiment, each transmission element 38 comprises a first part 50 in the form of a circular arc coaxial with the support element 18.

Preferably, the first cooperation element 40 and the second cooperation element 42 each extend in projection from the first part 50.

In this embodiment, the transformation of the movement in translation of the control member 26 from the first position to the second position by the transmission mechanism 28 into a movement in translation of the locking element 24 from the locking position (FIG. 7) to the unlocking position (FIG. 8) is carried out similarly to the first embodiment.

In one alternative, not illustrated, the control member is movable in translation according to a direction of translation D-D′ not perpendicular to the adjustment axis R-R′.

In particular, the direction of translation D-D′ forms, for example, an angle between 50° and 80° with the adjustment axis R-R′.

According to another alternative, not illustrated, the two transmission elements 38 pivot in the same direction of rotation to displace the locking element 24 from the locking position to the unlocking position.

1. A device for attaching a headrest on a vehicle seat with the possibility of adjusting the headrest relative to the vehicle seat according to an adjustment axis, the device for attaching comprising a receiving space for receiving a support element of the headrest, a locking element movable between a locking position wherein the locking element blocks the support element in translation according to the adjustment axis and an unlocking position wherein the locking element frees the support element in translation according to the adjustment axis, a control member, and a transmission mechanism comprising at least one rotatable transmission element movable in rotation around a rotation axis parallel to the adjustment axis, a rotation of each transmission element causing the displacement of the locking element from the locking position to the unlocking position.

2. The device for attaching according to claim 1, wherein the control member is movable in translation according to a direction of translation perpendicular to the adjustment axis.

3. The device for attaching according to claim 1, wherein the rotation axis of each transmission element is distinct from the adjustment axis.

4. The device for attaching according to claim 1, wherein the rotation axis of each transmission element coincides with the adjustment axis.

5. The device for attaching according to claim 1, comprising a tubular sleeve delimiting the receiving space, each transmission element being rotatably mounted on the tubular sleeve.

6. The device for attaching according to claim 5, wherein each transmission element is rotatably mounted on the tubular sleeve on the outside of the tubular sleeve.

7. The device for attaching according to claim 1, wherein the locking element is movable in translation between the locking position and the unlocking position.

8. The device for attaching according to claim 7, wherein the locking element is movable in translation according to a translation axis perpendicular to the adjustment axis.

9. The device for attaching according to claim 8, wherein the locking element is movable in translation according to the translation axis perpendicular to the adjustment axis, radial relative to the adjustment axis.

10. The device for attaching according to claim 1, wherein the locking element extends into the receiving space in the locking position and is clear of the receiving space or extends less into the receiving space in the unlocking position.

11. The device for attaching according to claim 1, wherein each transmission element comprises a first cooperation element by means of which it engages with the control member and a second cooperation element by means of which it engages with the locking element.

12. The device for attaching according to claim 11, wherein the first cooperation element and the second cooperation element are at a distance from each other according to the rotation axis of the transmission element.

13. The device for attaching according to claim 1, wherein the transmission mechanism comprises two transmission elements.

14. The device for attaching according to claim 13, wherein the two transmission elements pivot in opposite rotation directions to displace the locking element from the locking position to the unlocking position.

15. The device for attaching according to claim 1, comprising a return device comprising at least one elastic return member arranged to return the locking element from the unlocking position to the locking position.

16. A vehicle seat comprising a backrest equipped with the device for attaching according to claim 1 for attaching a headrest to the backrest.

17. The vehicle seat according to claim 16, wherein the receiving space is provided in the backrest.
